(19) United States
(12) Patent Application Publication
(10) Pub. No.: US 2024/0003369 A1
(43) Pub. Date: Jan. 4, 2024

(54) CONNECTOR FOR TWO COMPONENTS

(71) Applicant: Knapp Holding GmbH, Euratsfeld (AT)

(72) Inventor: Friedrich KNAPP, Bad Kreuzen (AT)

(73) Assignee: Knapp Holding GmbH, Euratsfeld (AT)

(21) Appl. No.: 18/039,872

(22) PCT Filed: Nov. 29, 2021
(86) PCT No.: PCT/EP2021/083403

§ 371 Date: Jun. 1, 2023

(30) Foreign Application Priority Data
Jan. 27, 2021 (EP) 21153738.6

(51) Int. Cl. F16B 12/20

(52) U.S. Cl. CPC F16B 12/2063

(57) ABSTRACT

The present invention relates to a connector for two components, the first component of which has a groove with a bore crossing the groove. The connector comprises a plate-shaped first fitting with a slot and a first opening crossing the slot, which first fitting can be inserted into the groove under an at least approximate alignment of the first opening with the bore, a second fitting which can be anchored on the second component and has a fin and a second opening passing through the fin, which fin can be inserted into the slot under an at least approximate alignment of the second opening with the first opening, and a bolt which has a conical end and can be passed through the bore, the first and the second opening in order to align them exactly with each other.

### CROSS-REFERENCE TO RELATED APPLICATION/S

This application is a National Phase application of International Application No. PCT/EP2021/083403 filed Nov. 29, 2021 which claims priority to the European Patent Application No. 21 153 738.6 filed Jan. 27, 2021, the disclosures of which are incorporated herein by reference.

### TECHNICAL FIELD

The present disclosed subject matter relates to a connector for two components, in particular wooden components, with two fittings, of which one can be anchored on one component and the other one on the other component. The disclosed subject matter relates in particular to connectors for such components of which at least one has a groove for inserting the respective fitting.

### BACKGROUND ART

Connectors of this kind are known for example from DE 196 04 243 C2 or DE 10 2014 101 158 A1. These connectors are intended for components having grooves with arc-shaped undercuts, for which the respective fitting has arc-shaped ribs for engagement in the undercuts. For anchoring the fitting on the associated component the fitting is pushed into the groove from its end in an arcuate movement and is then secured by the undercuts from being pulled out of the component transversely to the groove.

A disadvantage of the known connectors is that the fitting can move in the groove in longitudinal direction of the groove, which in the worst case can cause the components to fall apart. In DE 10 2014 101 158 A1 it was therefore proposed to additionally provide a bore crossing the groove in the respective component, which bore can be used for receiving an eccentric or a drive shaft for a locking hook, which can hook into the opposite fitting, in order to press the fittings against one another. At the same time, the eccentric inserted into the bore of the component prevents the fitting from sliding out in longitudinal direction of the groove. However, this structure is mechanically complex and not very suitable for use as a low-cost mass-produced article.

### BRIEF SUMMARY

The disclosed subject matter aims to overcome the disadvantages of the aforementioned prior art and to create a convector for two components, which provides a long-lasting and firm connection of the components in an inexpensive, simple and secure manner.

This aim is achieved with a connector for two components, the first component of which has a groove with a bore crossing the groove, which connector is characterized by:
a plate-shaped first fitting with a slot and a first opening crossing the slot, which first fitting can be inserted into the groove under an at least approximate alignment of the first opening with the bore,
a second fitting which can be anchored on the second component and has a fin and a second opening passing through the fin, which fin can be inserted into the slot with an at least approximate alignment of the second opening with the first opening, and
a bolt which has a conical end and can be passed through the bore, the first and second opening in order to align them exactly with each other.

The connector according to the disclosed subject matter uses the principle of aligning three openings, i.e. bore, first and second opening, by means of a common bolt, the conical end of which brings about the exact alignment of the openings and bores during its passing through and thus presses one fitting against the other. For this purpose, the position of the openings in the fittings and that of the bore in the component is chosen so that in a relaxed abutting position of the fittings against one another, their openings are slightly misaligned and are pressed against one another by the traversing bolt—by utilizing the basic elasticity of the material of the fittings and/or the component. This achieves a firm connection, which does not loosen even while in operation due to its internal frictional and pressing forces. In addition, the fittings are secured against slipping in longitudinal direction of the groove by the bolt passing through the bore and openings.

Optionally, the conical end of the bolt has an apex angle of 60° to 120°, e.g., about 90°. This facilitates the insertion of the bolt into the initially only approximately aligned openings and bore and the forcing of the exact alignment (orientation) during the passing through until the bolt is fully inserted.

According to a further optional feature of the disclosed subject matter the bolt is a screw bolt and the first opening is threaded. In this way, a force-increasing drive is provided for the advancement of the bolt into the bore and openings for their alignment and an additional fixation of the bolt is achieved. Even if this is not necessary, the second opening may also be threaded so that the two fittings are screwed together by the bolt.

In a further optional embodiment of the disclosed subject matter the fin is set off in relation to the rest of the second fitting in a stepped manner by a reduced plate thickness. The second fitting can thus optionally also be used individually, i.e. without a first fitting, for connecting to a first component: the first component then has a particularly narrow groove, which only serves for receiving the fin of the second fitting. Furthermore, the step-shaped offset of the second fitting allows its stepped surface to flush with the facing side of the first fitting, so that the two fittings are connected in a torsion-resistant manner.

In a further optional embodiment of the disclosed subject matter, the first opening is equipped with a collar which projects beyond the plate shape of the first fitting and can latch in the bore. The first fitting can snap with this collar into the bore from the inside when it is mounted on the first component—for example when it is pushed into the groove in an arcuate manner—and is thus secured against sliding into or out of the groove.

Optionally, the collar is reinforced on its outer periphery with webs to increase its stability. The webs can also be used as ramps for widening the groove until the collar snaps into the bore.

An optional embodiment of the connector for two components, of which the groove of the first component has an undercut in the shape of an arc of a circle on at least one of its groove flanks, is characterized in that the first fitting carries a rib in the shape of a circular arc for engagement in the undercut. Together with the pressing of the fittings by the bolt according to the disclosed subject matter, this results in a very stable connection of the components.

Thereby, the first fitting, seen in the direction of the first opening, optionally has approximately the shape of a sector of a circle, along the circular arc of which the rib is arranged. The first fitting can thus be pushed into the groove in an arcuate movement, as described, and then lies therein in a form-fitting manner.

A further optional embodiment of the connector for two components, of which the second component also has a groove with an undercut in the shape of an arc of a circle on at least one of its groove flanks, is characterized in that the second fitting also carries a rib in the shape of a circular arc for engagement in the undercut. This also achieves the advantages of a secure anchoring and a simple insertion by means of an arcuate “swing-in” movement.

Optionally, also the second fitting, seen in the direction of the second opening, has approximately the shape of a sector of a circle, along the circular arc of which the rib is arranged and from the chord of which the fin protrudes. The second fitting can thus be sunk in a form-fitting manner into the groove of the second component, wherein the fin projects from the second component.

In each of the mentioned embodiments, optionally the first fitting and/or the second fitting carry at least one cutting edge in the shape of a circular arc for cutting into a groove flank of the groove of the first or second component, respectively. The cutting edge cuts an additional undercut in the groove of the component, which provides an addition tensile anchoring transverse to the longitudinal direction of the groove and an additional pressing effect against displacement in longitudinal direction of the groove.

According to a further optional feature of the disclosed subject matter at least one of the parts fin and slot has a latching projection, a spring clip or a resilient latching pawl and the other part has a latching recess interacting therewith for latching the fin upon insertion into the slot. In this way a temporary fixation of the components equipped with the fittings is already achieved before the bolt is passed through, which facilitates the assembly and the subsequent passing through of the bolt for pressing the fittings together.

It is particularly advantageous when the slot has latching projections lying opposite to one another in its entry region and the fin has latching recesses on both sides interacting therewith. This results in a simple and secure locking of the fin in the slot when connecting the fittings.

### BRIEF DESCRIPTION OF THE DRAWINGS/FIGURES

The disclosed subject matter is explained in more detail below with reference to embodiments shown in the accompanying drawings. In the drawings:

FIG. 1 shows the connector of the disclosed subject matter in a partially interconnected perspective view;

FIG. 2 shows an exemplary first component with groove and bore for receiving the lower fitting of the connector of FIG. 1 in a perspective view;

FIG. 3 shows the upper fitting of the connector of FIG. 1 in a side view;

FIG. 4 shows the lower fitting of the connector of FIG. 1 in a side view;

FIG. 5 shows a cross-section of the partially assembled fittings of the connector of FIG. 1 in a sectional view along the section lines V-V in FIGS. 3 and 4;

FIG. 6 shows a cross-section of the opening region of the fittings of the connector of FIGS. 1 to 5 after assembly and before the insertion of the bolt;

FIG. 7 shows an alternative embodiment of the lower fitting of the connector of FIGS. 1 to 6; and

FIG. 8 shows the installation position of the connector of FIGS. 1 to 6 with the lower fitting of FIG. 7 in a partially broken perspective view before the insertion of the bolt.

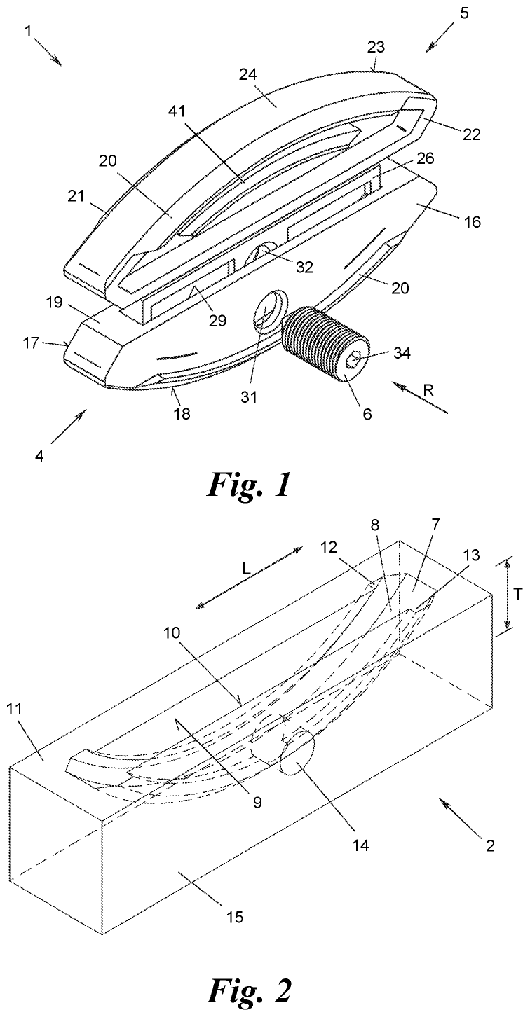

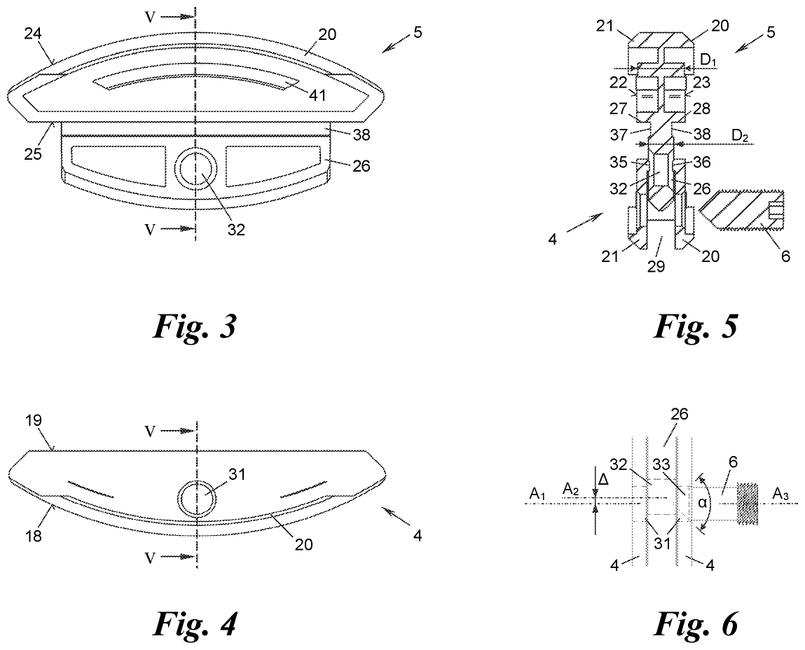

FIGS. 1 to 5 show a connector 1 for connecting two components 2, 3 (see FIG. 2, 8). The components 2, 3 can be any type of component made of any material, such as wood, metal, plastic or the like.

The connector 1 is intended in particular for connecting wooden components 2, 3, for example in furniture construction or industrial timber construction. Depending on the stability requirements, the connector 1 can be made of any material, for example wood, plastic, metal or combinations thereof. Particularly for small-sized connectors 1 used in furniture construction, the connector 1 can be made entirely of plastic, for higher stability requirements, e.g., for load-bearing constructions in industrial timber construction, the connector can be made entirely of metal.

The connector 1 is composed essentially of an approximately plate-shaped or platelet-shaped first fitting 4, an approximately plate-shaped or platelet-shaped second fitting 5 and a bolt 6 pressing them together. The first fitting 4 is anchored on the first component 2 and the second fitting 5 is anchored on the second component 3. By tensioning the fittings 4, 5 against one another with the aid of the bolt 6 the components 2, 3 are firmly connected to one another—either permanently or detachably.

For anchoring of the first fitting 4, the first component 2 has a groove 7 with a groove base 8 approximately in the shape of an arc of a circle and groove flanks 9, 10 on both sides (FIG. 2). The groove 7 runs on the upper side 11 of the component 2 in a longitudinal groove direction L and has its greatest depth T, measured from the upper side 11 of the component 2 to the groove base 8, at its centre. The groove 7 has a respective undercut 12, 13 in the shape of an arc of a circle on at least one its groove flanks 9, 10, optionally on both groove flanks 9, 10.

The component 2 is further traversed by a bore 14 crossing the groove 7 approximately normal to its longitudinal direction L, and in such a way that the bore 14 is accessible from at least one side 15 of the component 2. The bore 14 can pass completely through the component 2 or be a blind bore which extends from the side 15 into the groove 7, i.e. breaks through one groove flank 9 thereof and either leaves the opposite groove flank 10 untouched or penetrates the same.

The first fitting 4 is formed on its outer sides complementary to the groove 7 and has, seen in direction R normal to its plate shape extension plane, i.e. normal to its lateral sides 16, 17, approximately the shape of a sector of a circle, i.e. its peripheral shape follows a circular arc on its lower side 18 and a circle chord on its upper side 19. On its lateral sides 16, 17 the fitting 4 has a respective projecting rib 20, 21 following the circular arc shape of its lower side 18. By means of the ribs 20, 21 the fitting 4 can be pushed into the groove 7 from its one end in an arcuate movement, the ribs 20, 21 engaging in the undercuts 12, 13. In the fully inserted position, the fitting 4 is positioned within the groove 7 in a form-fitting manner, its upper side 19 being flush with the upper side 11 of the component 2 in which the groove 7 is machined.

For anchoring the second fitting 5 on the second component 3 essentially the same construction can be used, i.e. the second component 3 (FIG. 8) is equipped with a similar groove 7 with undercuts 12, 13 in the shape of an arc of a circle; however, a transverse bore 14 is not necessary in the second component 3. The second fitting 5 also has a plate-shape or platelet-shape, and, seen in direction R normal to its plate shape extension plane, also has approximately the shape of a sector of a circle and ribs 20, 21 in the shape of a circular arc on its lateral sides 22, 23, which ribs 20, 21 follow the arcuate shape of its upper side 24. A fin 26 projects from the underside 25, the chord of the circle sector form, which fin is used for connecting with the other fitting 4.

The fin 26 of the second fitting 5 is, seen in cross-section (FIG. 5), set off from the rest of the fitting 5 by steps 27, 28 on the lateral sides 22, 23, i.e. the plate thickness D₂ of the fin 26 is smaller than the plate thickness D₁ of the rest of the fitting 5.

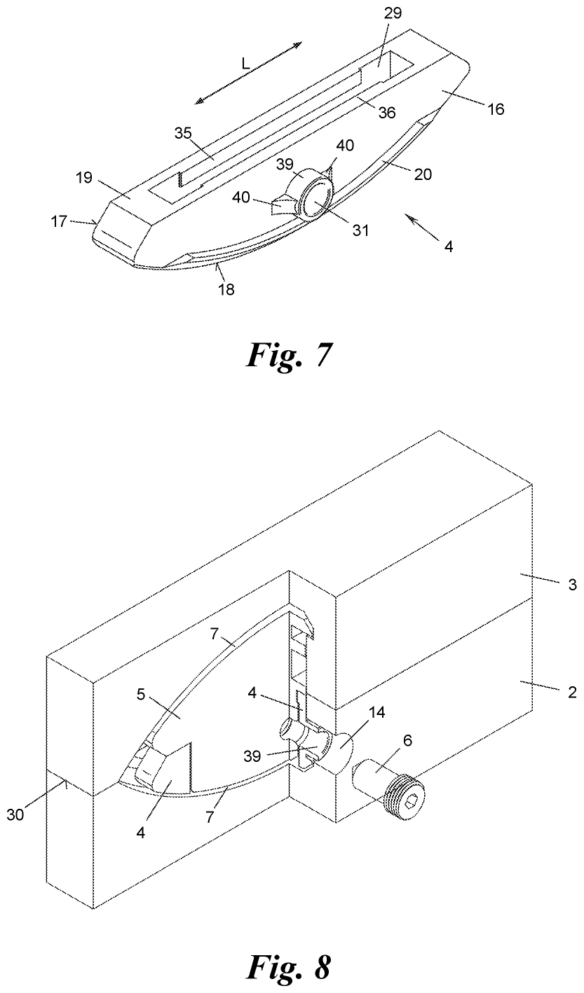

The first fitting 4 has a slot 29 which is complementary to the fin 26 of the second fitting 5 (FIG. 7). After anchoring the fittings 4, 5 in the grooves 7 of the components 2, 3, the fin 26 of the fitting 5 is inserted into the slot 29 of the fitting 4, until the steps 27, 28 of the fitting 5 abut against the upper side 19 of the fitting 4. If the grooves 7 are machined into the components 2, 3 so that in the fully inserted position of the fitting 5 in the component 3 the steps 27, 28 are flush with that side 30 of the component 3 (FIG. 8), in which the groove 7 is machined, and the upper side 19 of the fitting 4 is flush with the upper side 11 of the component 2, then the sides 11 and 30 of the components 2, 3 abut against one another at the same time.

The bolt 6 is used to press the two fittings 4, 5 and thus the components 2, 3 against one another in this contact position. To this end, the bolt 6 is passed via the bore 14 in the one component 2 through a first opening 31 crossing the slot 29 of the first fitting 4 and through a second opening 32 passing through the fin 26 of the second fitting 5, see FIG. 6.

The openings 31, 32 are arranged in the fittings 4, 5 so that they are only approximately aligned with one another during the assembly of the connection, when the fittings 4, 5 are already fully inserted into the grooves 7 of the components 2, 3 but the fittings 4, 5 are only relatively loosely in contact with one another. FIG. 6 shows this approximate alignment or slight misalignment of the fittings 4, 5: the axis A₁ of the opening 31 of the first fitting 4 deviates slightly from the axis A₂ of the opening 32 in the fin 26 of the second fitting more precisely, it is further away from the arc end (the upper side 24) of the second fitting 5 than its axis A₂.

In this approximate alignment position, the bolt 6 is now inserted via the bore 14 of the first component 2. The bolt 6 has a conical end 33 and by acting as a sliding ramp or run-up slope aligns the openings 31 and 32 (i.e. their axes A₁ and A₂) with one another and with respect to the axis A₃ of the bore 14. This presses the two fittings 4, 5 firmly against one another, if necessary also using the intrinsic elasticity of the material from which the components 2, 3 and the fittings 4, 5 are made.

The bolt 6 can be a plug-in bolt or—as shown—a screw bolt, for which the first opening 31, optionally also the second opening 32, has a corresponding thread. If desired, the bore 14 could also be provided with a corresponding thread. The screw bolt 6 can be rotated from outside the component 2 over the bore 14, e.g., via a screw head or (here:) Allen key 34.

In order to facilitate the insertion of the bolt 6—either by plugging-in or screwing—into the openings 31, 32 while simultaneously aligning them, the conical end 33 of the bolt 6 has an apex angle α of for example 10° to 150°, optionally 30° to 150°, e.g., 60° to 120°, and, say, about 90° as shown in FIG. 6. The conical shell of the cone end 33 thus forms a run-up slope or ramp for the facing annular edges of the openings 31 and 32 in order to centre the bolt 6 therein, as can be seen in FIG. 6.

For the temporary mutual fixation of the fittings 4, 5 before the insertion of the bolt 6, the fittings 4, 5 can be provided with one or more latching projections, spring clips, resilient latching pawls or the like and one or more latching recesses cooperating therewith. In this way, the fin 26 can for example be latched into the slot 29 (“clipped in”) when being inserted. FIGS. 5 and 7 show a special configuration of such latching projections and latching recesses in the form of latching projections 35, 36 which extend in longitudinal direction L of the slot 29 in the entry region of the slot 29 and can engage in latching recesses 37, 38 cooperating therewith on both lateral sides of the fin 26.

FIGS. 7 and 8 show a further embodiment of the first fitting 4. The opening 31 of the fitting 4 is here provided with a collar 39 projecting beyond the plate shape of the fitting 4, i.e. its lateral side 16. When pushing the fitting 4 into the bore 7 of the component 2 in an arcuate movement, the collar 39 engages or snaps into the bore 14 of the component 2 from inside the groove in the fully inserted position of the fitting 4, thus securing the fitting 4 against a displacement in longitudinal direction of the groove. Of course, the height of the collar 39 should only be high enough to allow a temporary elastic expansion of the groove 7 until the collar 39 snaps into the groove 14, without damaging the groove 7 or the component 2.

The collar 39 can be reinforced on its outer circumference by means of webs 40, which support it relative to the lateral side 16 of the fitting 4. The webs 40 can also be configured as sliding ramps in the direction of the arcuate insertion movement of the fitting 4, as shown in FIG. 7.

To improve the anchoring of the fittings 4, 5 in the grooves 7 of the components 2, 3 each of the fittings 4, 5 can optionally be provided with one or more cutting edges 41 in the shape of a circular arc for cutting into one or both groove flanks 9, 10 of the groove 7. The cutting edges 41 run for example on the lateral sides 16, 17, 22, 23 of the fittings 4, 5 concentrically and radially inside the arcuate ribs 20, 21.

It is understood that the fittings 4, 5 can also be anchored on the components 2, 3 in other ways than in arcuate grooves 7 with arcuate undercuts 12, 13. For example, the grooves 7 could not have an arcuate groove base 8, e.g., could be rectangular or square pockets in the components 2, 3. Also, the grooves 7 could not have arcuate undercuts 12, 13 and the ribs 20, 21 on the fittings 4, 5 could be omitted and the latter simply be inserted into the grooves 7 in direction of the depth T of the grooves.

Lastly, it is also possible to use the fitting 5 provided with the fin 26 without the fitting 4, simply by inserting the fin 26 into a groove 7 with a reduced width D₂, and then pinning it with the bolt 6 traversing the bore 14 and the opening 32 thus pressing it directly against the opposite component 2.

The disclosed subject matter is not limited to the embodiments shown, but encompasses all variants, modifications and combinations thereof, which fall under the scope of the appended claims.

What is claimed is:

1. A connector for two components, the first component of which has a groove with a bore crossing the groove, comprising:
a plate-shaped first fitting with a slot and a first opening crossing the slot, which first fitting can be inserted into the groove under an at least approximate alignment of the first opening with the bore,
a second fitting which can be anchored on the second component and has a fin and a second opening passing through the fin, which fin can be inserted into the slot under an at least approximate alignment of the second opening with the first opening, and
a bolt which has a conical end and can be passed through the bore, the first and the second opening in order to align the bore, the first and the second opening with each other.

2. The connector according to claim 1, wherein the conical end has an apex angle of 60° to 120°.

3. The connector according to claim 1, wherein the bolt is a screw bolt and the first opening is threaded.

4. The connector according to claim 3, wherein the second opening is threaded.

5. The connector according to claim 1, wherein the fin is set off in relation to the rest of the second fitting in a stepped manner by a reduced plate thickness.

6. The connector according to claim 1, wherein the first opening is equipped with a collar which projects beyond the plate shape of the first fitting and can latch in the bore.

7. The connector according to claim 6, wherein the collar is reinforced on its outer circumference by means of webs.

8. The connector according to claim 1 for two components, of which the groove of the first component has an undercut in the shape of an arc of a circle on at least one of its groove flanks, wherein the first fitting has a rib in the shape of a circular arc for engagement in the undercut.

9. The connector according to claim 8, wherein the first fitting, seen in the direction of the first opening, has approximately the shape of a sector of a circle, along a circular arc of which the rib is arranged.

10. The connector according to claim 1 for two components, of which the second component has a groove with an undercut in the shape of an arc of a circle on at least one of its groove flanks, wherein the second fitting has a rib in the shape of a circular arc for engagement in the undercut.

11. The connector according to claim 10, wherein the second fitting, seen in the direction of the second opening, has approximately the shape of a sector of a circle, along a circular arc of which the rib is arranged and from a chord of which the fin protrudes.

12. The connector according to claim 1, wherein the first fitting and/or the second fitting has at least one cutting edge in the shape of a circular arc for cutting into a groove flank of the groove of the first or second component, respectively.

13. The connector according to claim 1, wherein one of the parts fin and slot has a latching projection, a spring clip or a resilient latching pawl and the other one has a latching recess interacting therewith to latch the fin upon insertion into the slot.

14. The connector according to claim 13, wherein the slot has latching projections lying opposite to one another in its the slot's entry region and the fin has latching recesses on both sides interacting therewith.

15. The connector according to claim 1, wherein the conical end has an apex angle of about 90°.

16. The connector according to claim 2, wherein the bolt is a screw bolt and the first opening is threaded.

17. The connector according to claim 16, wherein the second opening is threaded.

18. A connector comprising:
a first fitting having a slot and a first opening extending into the slot, the first fitting adapted to be mounted in a groove of a first component having a bore extending into the groove such that the first opening approximately aligns with the bore in the first component;
a second fitting adapted to be mounted in a groove of a second component, the second fitting including a fin having a second opening extending through the fin, the fin configured to be inserted into the slot of the first fitting such that the second opening in the fin approximately aligns with the first opening in the first fitting; and
a fastener having a conical end configured to be passed through the bore, the first opening and the second opening to thereby align the bore, the first opening and the second opening with each other.

19. The connector according to claim 18, wherein the fastener is a threaded bolt and wherein the second opening in the fin is threaded.

20. The connector according to claim 18, wherein the conical end of the fastener has an apex angle of 60° to 120°.
